(19) United States
(12) Patent Application Publication
(10) Pub. No.: US 2017/0148294 A1
(43) Pub. Date: May 25, 2017

(54) Systems and Methods of Enclosed Area Alert

(71) Applicant: Kapali Eswaran, South Ponte Vedra Beach, FL (US)

(72) Inventor: Kapali Eswaran, South Ponte Vedra Beach, FL (US)

(21) Appl. No.: 15/353,734

(22) Filed: Nov. 16, 2016

Related U.S. Application Data
(60) Provisional application No. 62/219,385, filed on Sep. 16, 2015.

(51) Int. Cl. G08B 21/02; G08B 29/18; B60Q 9/00

(52) U.S. Cl. CPC G08B 21/02; B60Q 9/00; G08B 29/185

(57) ABSTRACT

Example embodiments of the disclosed systems and methods of enclosed area alert pertain to preventing damages to infants, animals, or perishables (as non-limiting examples) in environments such as cars, enclosed trailers, or enclosed rooms. Damages may occur when environmental conditions meet extremes, such as the temperature getting too hot or too cold and/or the humidity getting too high or too low, among other environmental conditions. Example embodiments of the disclosed systems and methods (i) identify whether the items of concern (an infant, an animal or a perishable item, etc.) are present in the environment, (ii) measure the temperature and/or humidity of the environment and (iii) take alert action such as sounding an alarm, informing the owner etc.

### CROSS-REFERENCE TO RELATED APPLICATION

This application claims benefit to U.S. provisional patent application Ser. No. 62/219,385, filed on Sep. 16, 2015, which is incorporated by reference herein.

### TECHNICAL FIELD

The present disclosure is generally related to safety and, more particularly, is related to systems and methods of enclosed area alerts.

### BACKGROUND

An alarming number of children die from heat-related deaths after being trapped inside vehicles. Even the best of parents or caregivers can unknowingly leave a baby in a car; and the end result can be injury or even death. Vehicular heat stroke tragedies change the lives of parents, families, and communities forever.

Children left in a motor vehicle for even short time periods in moderate ambient temperatures (e.g. 21C) are at risk for hyperthermia. The internal temperature within a closed motor vehicle ascends rapidly in the first 15 min despite variations in the rate of increase due to vehicle type, color, and window tinting. On average, temperatures increase 1.7-1.9C per 5 min. Within 30 min, 80% of the temperature increase is accounted for and within 60 min vehicles have reached identical peak temperatures, regardless of whether windows are closed or cracked open.

Two factors make children more prone to hyperthermia than adults—children have a greater surface area to body mass ratio than adults and a child's thermoregulation is less efficient than an adults. In areas of high humidity the body's cooling method (perspiration/evaporation) is less effective. When considering infants usually remain clothed below window level in cushioned seats when being transported in a vehicle, one can observe their significant disadvantage in reduced total surface area available for the body's natural cooling method to be most effective. Therefore, children are especially prone to develop hyperthermia when inside a closed, hot vehicle. It should be noted that pets and perishables left in enclosed areas are similarly subject to hyperthermia. Solutions for preventing child injury or death from being left in an enclosed area have not sufficiently addressed these potential harms.

### SUMMARY

Example embodiments of the present disclosure provide systems of enclosed area alert. Briefly described, in architecture, one example embodiment of the system, among others, can be implemented as follows: an environmental condition sensor configured to sense an environmental condition in an enclosed area; a control unit configured to monitor the environmental condition; an alert system configured to signal an alert when the control unit determines that the environmental condition in the enclosed area is outside of a predetermined parameter range; and a positive identification system configured to enable the alert system when a monitoring condition exists.

Embodiments of the present disclosure can also be viewed as providing methods for enclosed area alert. In this regard, one embodiment of such a method, among others, can be broadly summarized by the following steps: sensing an environmental condition in an enclosed area; monitoring the environmental condition; enabling an alert system when a monitoring condition exists; and signaling an alert when the monitored condition is outside a predetermined parameter range and when a monitoring condition exists.

### BRIEF DESCRIPTION OF THE DRAWINGS

FIG. 1 is a system diagram of an example embodiment of a control system of an enclosed area alert system.

FIG. 2 is a system diagram of an example embodiment of a positive identification system of an enclosed area alert system.

FIG. 3 is a system diagram of an example embodiment of an integrator system of an enclosed area alert system.

FIG. 4 is a system diagram of an example embodiment of a monitoring system of an enclosed area alert system.

FIG. 5 is a system diagram of an example embodiment of a false alarm avoidance system of an enclosed area alert system.

FIG. 6 is a flow diagram of an example embodiment of an enclosed area alert method.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non- limiting examples and are merely examples among other possible examples.

Example embodiments of the disclosed systems and methods of enclosed area alert pertain to preventing damages to infants, animals, or perishables (as non-limiting examples) in environments such as cars, enclosed trailers, or enclosed rooms. Damages may occur when environmental conditions meet extremes, such as the temperature getting too hot or too cold and/or the humidity getting too high or too low, among other environmental conditions.

The aforementioned problem has been around a long, long time and no solution that is workable has been advanced. Any solution should be effective in preventing damages and also in not creating false alarms. This disclosure provides a novel solution to this known problem.

Example embodiments of the disclosed systems and methods (i) identify whether the items of concern (an infant, an animal or a perishable item, etc.) are present in the environment, (ii) measure the temperature and/or humidity of the environment and (iii) take alert action such as sounding an alarm, informing the owner etc.

In the disclosure presented herein, an infant is used as an example of an item of concern, an automobile is used as an example of an environment to be monitored, and sounding an alarm is used as an example of an alert. An example embodiment of the disclosed systems comprises an environmental sensing system (ESS), a positive identification system (PIS), and an integrator System (IS).

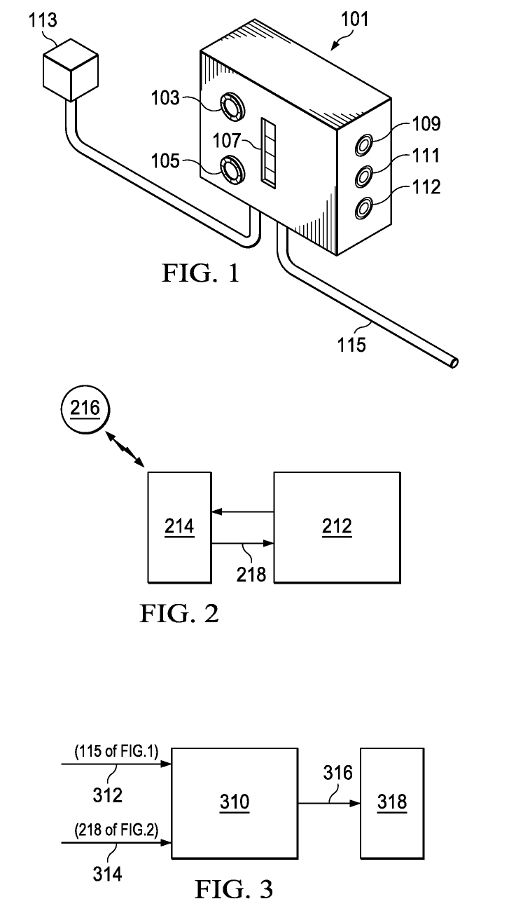

Environmental sensing systems, such as a temperature sensing system, comprises a control unit that sets minimum and maximum temperatures (range) and a thermometer which feeds the values to the control unit. FIG. 1 provides an example embodiment of a system of enclosed area alert, including control unit 101, low key set 103, high key set 105, adjuster 107, mode switch 109, done key 111 and thermometer 113. A non-limiting example of thermometer 113 is a digital electronic thermometer.

The ESS may, in an example embodiment, operate in two modes: set (SET) and operate (OP). The mode is set by using mode switch 109. First, the user sets mode switch 109 to the set mode, presses low key set 103, adjusts adjuster 107 to the value desired, and presses done key 111 which sets the low end of the range. Similarly, the user sets the high end of the range. Once the range values have been set, the user sets the mode switch 109 to OP mode. When in OP mode, control unit 101 of ESS is ready to read the temperature values from thermometer 113. Control unit 101, periodically (every few seconds, for example), reads the temperature values from thermometer 113 and compares it with the low and high end range values that have been set. If and when the temperature value is outside the range values, control unit 101 outputs a signal on out-of-range line 115. The signal on out-of-range line 115 is fed to an Integrator System (IS) and remains in an ON state until control unit 101 is reset by reset switch 112. If one is interested in humidity control, the ESS may include a humidity measurement and control system.

Positive identification system (PIS) may be used to avoid false alarms, namely sounding an alarm when the temperature in the car is high, but there is no baby left in the car. In a non-limiting example embodiment, PIS deploys Radio-Frequency Identification and Detection (RFID) technology. An RFID system may comprise a tag/transponder and a reader. Upon receiving a command signal from a control unit, the reader emits a radio frequency signal to the tag, which when receiving the signal from the reader sends a response to the reader. The response can be any information that is programmed into the transponder. In an example embodiment, the information may be “I am here”. The tag may be relatively small. In an example embodiment, the tag may be attached to or incorporated into the baby's ornaments such as a necklace or the baby's clothes, shoes, or even diapers. The tag may be tied to or incorporated into the collar for a pet. The tag may be tied to or incorporated into the basket that holds perishables.

Now, referring to FIG. 2, an example embodiment of the PIS system comprises control unit 212, RFID reader 214 and tag 216. Periodically, control unit 212 sends a command signal to reader 214 to send a signal to tag 216. If reader 214 receives a response from tag 216, reader 214 outputs a signal, on line 218. A signal value on line 218 indicates to control unit 212 that the “Tagged object” (a baby, a pet, or a bushel of perishables) is present in the enclosed area.

An example embodiment of Integrator System (“IS”), shown in FIG. 3, represents control logic that receives two inputs 312 (which is the same as 115 of ESS of FIGS. 1) and 314 (which is the same as 218 of PIS of FIG. 2). When control logic 310 detects values on both lines 312 and 314, control logic 310 actuates line 316 alerting alert subunit 318 of the IS. When alert subunit 318 is alerted, alert subunit 318 takes an alert action. Non-limiting example alert actions include notifying the owner by mobile means, contacting emergency operator 911, and/or sounding an audible alarm announcing that “an occupant is present; climate is bad and is damaging to the occupant and there is trouble that needs help,” among others.

Included in the disclosed systems and methods of enclosed area alert is a means to detect presence of a specific object including perishables, people, and pets in an enclosed area, a means to frequently measure the environmental data, including temperature and/or humidity in the enclosed area, and a means to alert if the specific object is present in the said enclosed area if the climate measurements differs from the lower and upper limits that are settable.

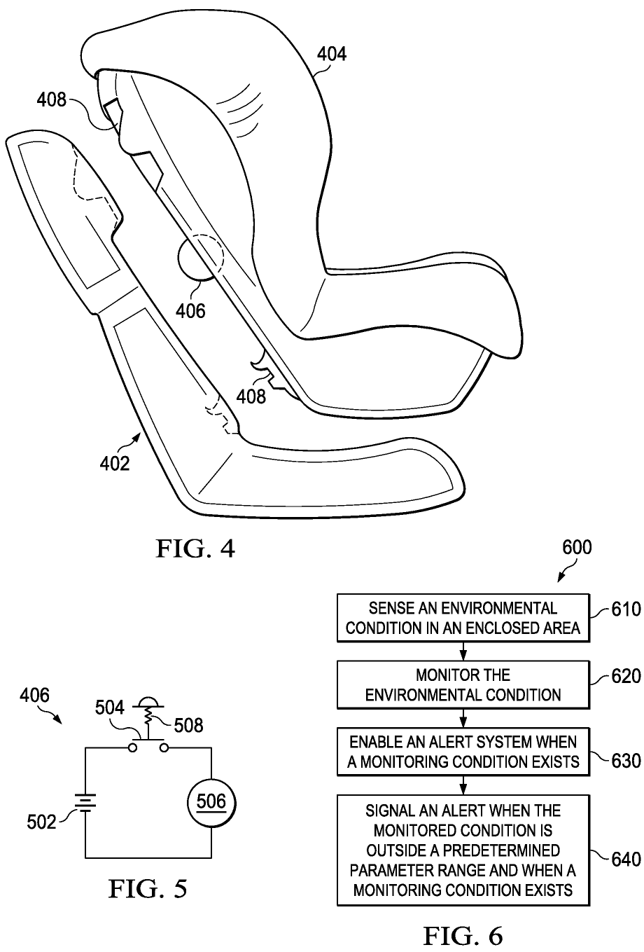

Attaching the tag to a baby's car seat or to a stroller or to the baby himself, may be of concern in several ways including the possibilities that the baby may hurt himself, the tag might cause a rash, or the baby might remove the tag. To address these concerns, an alternative embodiment is provided in FIG. 4. The system of FIG. 4 includes (pillow-like, for example) pad 404 to be placed on car seat 402. Pad 404 may be placed between the baby's bottom/baby's back and the baby's car seat. Pad 404 may be attached to car seat 402 by use of fastener(s) 408. Pad 404 comprises presence module 406, described in further detail below.

In FIG. 5, an example embodiment of presence module 406 is provided in further detail. Presence module 406 comprises power supply 502, switch 504, active RFID tag 506, and spring 508. The contacts of switch 504 are normally open and close when pressure (weight) is applied to the pad (such as when a baby is placed on the pad). One of the two contacts of switch S is connected to power supply 502. The second contact of switch 504 is connected to active RFID tag 506. When the baby is not placed on the pad (i.e., the baby is not placed on the car seat), tag 506 is not powered. However, when the baby is placed on the seat, when the contacts of switch 504 close, the tag receives power and responds to the signals from the reader (such as reader 214 of FIG. 2).

Spring 508, connected to switch 504 keeps the contacts open with no weight applied to switch 504. The coil strength of spring 504 may be chosen in relationship with a baby's normal weight. This would avoid an object like a doll being placed on the pad being mistaken for a baby. Weight sensitive systems are a part of what are commonly known in the industry as strain gauges. There are several strain gauges that are available in the marketplace. Pad 404 may be attached to car seat 404 by fastener means 408 such as non-limiting examples of hook and loop fasteners or press buttons/snaps.

FIG. 6 is flow diagram 600 of an example embodiment of an enclosed area alert method. In block 610, an environmental condition in an enclosed area is sensed. In block 620, the environmental condition is monitored. In block 630, an alert system is enabled when a monitoring condition exists. In block 640, an alert is signaled when the monitored condition is outside a predetermined parameter range and when a monitoring condition exists.

The above example embodiments illustrate a means in which a definitive confirmation that a baby to be protected from adverse environmental conditions is indeed present in the environment (in an example embodiment, the confirmation means is not attached to the baby), a means of monitoring the environment, and an alert means alerting that actions are required when the climate becomes out-of-range. The disclosed embodiments solve a long felt need, eliminate objections of false alarm, and attach no foreign object to a baby.

In the cases where attaching a tag to the object to be protected is not possible, an alternative embodiment may include a device that uses very low power microwave radar to detect the unique signature of a human's breathing pattern and heartbeat. The low power microwave radar device is non-invasive and use low levels of microwave radiation. Once turned on, the low power microwave radar device outputs a signal when it finds a human being within an area that is definable (such as a 10 foot diameter sweep). The operation of the embodiment in FIG. 3 is similar as before except that line 314 would be the output of the low power microwave radar device instead of line 218 in the RFID subsystem in PIS. This approach is useful, for example, in monitoring trunks of automobiles where a pet or a person gets locked in by mistake or on purpose. This modification describes a means to detect presence of a specific object including perishables, people, and pets in an enclosed area without attaching any external identification means to the said specific object, a means to frequently measure the environmental conditions including temperature and/or humidity, among other environmental conditions in the enclosed area, and a means to alert if the specific object is present in the enclosed area if the environmental condition measurements differ from the lower and upper limits that are settable.

The flow chart of FIG. 6 shows the architecture, functionality, and operation of a possible implementation of the enclosed area alert software. In this regard, each block represents a module, segment, or portion of code, which comprises one or more executable instructions for implementing the specified logical function(s). It should also be noted that in some alternative implementations, the functions noted in the blocks may occur out of the order noted in FIGS. 6. For example, two blocks shown in succession in FIG. 6 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present disclosure has been described in detail, it should be understood that various changes, substitutions and alterations can be made thereto without departing from the spirit and scope of the disclosure as defined by the appended claims.

Therefore, at least the following is claimed:

1. A system comprising:
an environmental condition sensor configured to sense an environmental condition in an enclosed area;
a control unit configured to monitor the environmental condition;
an alert system configured to signal an alert when the control unit determines that the environmental condition in the enclosed area is outside of a predetermined parameter range; and
a positive identification system configured to enable the alert system when a monitoring condition exists.

2. The system of claim 1, wherein the environmental condition sensor senses at least one of temperature and humidity.

3. The system of claim 1, wherein the monitoring condition exists if an item to be monitored is present.

4. The system of claim 3, wherein the monitored item presence is determined by an radio frequency (RF) identification (ID) reader detecting an RFID tag on an item to be monitored.

5. The system of claim 1, wherein the alert comprises at least one of notifying an owner by wireless message, contacting an emergency operator, and sounding an audible alarm.

6. The system of claim 1, further comprising an adjustable strain gauge configured in relation to a weight of the monitored item to avoid false alarms.

7. The system of claim 1, further comprising a pad comprising a presence module, the pad fastenable and appurtenant to an item in the enclosed area.

8. A method, comprising:
sensing an environmental condition in an enclosed area;
monitoring the environmental condition;
enabling an alert system when a monitoring condition exists; and
signaling an alert when the monitored condition is outside a predetermined parameter range and when a monitoring condition exists.

9. The method of claim 8, wherein the sensed environmental conditions are at least one of temperature and humidity.

10. The method of claim 8, wherein the monitored condition exists when an item to be monitored is present.

11. The method of claim 10, further comprising determining the monitored item presence with an RFID reader detecting an RFID tag on the item to be monitored.

12. The method of claim 8, wherein signaling the alert comprises at least one of notifying an owner by wireless messaging, contacting an emergency operator, and sounding an audible alarm.

13. The method of claim 8, further comprising avoiding false alarms by measuring weight of a monitored item on a strain gauge.

14. The method of claim 8, further comprising determining presence of an item to be measured in the enclosed area with a pad fastenable and appurtenant to the item, the pad comprising a presence module.

15. A vehicle comprising:
an environmental condition sensor configured to sense an environmental condition in an enclosed area;
a control unit configured to monitor the environmental condition;
an alert system configured to signal an alert when the control unit determines that the environmental condition in the enclosed area is outside of a predetermined parameter range; and
a positive identification system configured to enable the alert system when a monitoring condition exists.

16. The system of claim 15, wherein the environmental condition sensor senses at least one of temperature and humidity.

17. The system of claim 15, wherein the monitoring condition exists if an item to be monitored is present.

18. The system of claim 17, wherein the monitored item presence is determined by an radio frequency (RF) identification (ID) reader detecting an RFID tag on an item to be monitored.

19. The system of claim 15, wherein the alert comprises at least one of notifying an owner by wireless message, contacting an emergency operator, and sounding an audible alarm.

20. The system of claim 15, further comprising an adjustable strain gauge configured in relation to a weight of the item to avoid false alarms.

21. The system of claim 15, further comprising a pad comprising a presence module, the pad fastenable and appurtenant to an item in the enclosed area.
